(19) United States
(12) Patent Application Publication
(10) Pub. No.: US 2012/0126695 A1
(43) Pub. Date: May 24, 2012

(54) COLOR CONTROL FOR LOW WATTAGE CERAMIC METAL HALIDE LAMPS

(75) Inventor: Raghu Ramaiah, Solon, OH (US)

(73) Assignee: General Electric Company

(21) Appl. No.: 12/953,693

(22) Filed: Nov. 24, 2010

(51) Int. Cl. H01J 61/18; H01J 17/04

(52) U.S. Cl. 313/633; 313/638

(57) ABSTRACT

The invention relates generally to ceramic metal halide lamps. More particularly, the invention relates to low wattage ceramic metal halide lamps having enhanced color control. In one embodiment according to the invention, such lamps may be characterized by a shank length (SL) to shank diameter (SD) ratio of between 5.1 and 15.5. Further, the lamp exhibits a sigma CCT of less than about 100° K.

### BACKGROUND OF THE DISCLOSURE

The invention relates generally to low wattage ceramic metal halide lamps. More particularly, the invention relates to low wattage ceramic metal halide lamps having enhanced color control. Of course, the invention is suited for use in other lighting applications, for example other lamps where color control may be desired.

Low wattage ceramic metal halide lamps are well known in the lighting field. Such lamps, also referred to as high intensity discharge (HID) lamps, generally produce light by ionizing a fill, also referred to as a “dose,” such as a mixture of metal halide and mercury in an inert gas, such as argon, by passing an arc between two electrodes. The fill and the electrodes are sealed within a discharge chamber which is capable of maintaining the pressure of the energized fill and further transmits the emitted light to the exterior of the chamber. Ionization of the fill or dose by the electric arc that passes between the electrodes results in the emission of a desired spectral energy distribution, the wavelength of which is dependent on the composition of the dose. For example, halides provide spectral energy distributions that offer a broad choice of light properties, including color temperatures, color rendering, and luminous efficiency.

Conventionally, the discharge chamber in a discharge lamp was formed from a vitreous material such as fused quartz. Fused quartz, however, has certain disadvantages, arising primarily from its reactive properties at high operating temperatures. For example, in a quartz lamp, at temperatures greater than about 950-1000° C., the halide fill reacts with the glass to produce silicates and silicon halide, which results in depletion of the fill constituents. In addition, at elevated temperatures, sodium tends to permeate through the quartz wall, further depleting the fill. Over time, depletion of the fill in the foregoing manners results in color shift, reducing the useful life of the lamp. Color rendition, as measured by the color rendering index (CRI or Ra) tends to be moderate in known quartz metal halide (QMH) lamps, typically falling within the range of 65-70 CRI, with moderate lumen maintenance, typically about 65-70%, and moderate to high efficacies of 100-150 lumens per watt (LPW). U.S. Pat. Nos. 3,786,297 and 3,798,487 disclose quartz lamps which use high concentrations of cerium iodide in the fill to achieve relatively high efficiencies of 130 LPW, even though such is achieved at the expense of the CRI. These lamps are, however, limited in performance by the maximum wall temperature achievable in a quartz arctube.

In light of the foregoing, ceramic discharge chambers able to operate at higher temperatures were developed. Lamps having ceramic discharge chambers, for example Ceramic metal halide (CMH) lamps, achieve improved color temperatures, color renderings, and luminous efficacies.

A critical parameter of HID lamps is their color coordinates, x and y. The CIE system characterizes colors by a luminance parameter Y and two color coordinates x and y which specify this point on the chromaticity diagram. The CIE system offers more precision in color measurement because these parameters are based on the spectral power distribution (SPD) of the light emitted from a light source or a colored object, and are factored by sensitivity curves which have been measured for the human eye. Based on the fact that the human eye has three different types of color sensitive cones, the response of the eye is best described in terms of three “tristimulus values”. Once a color measurement has been made in this manner, any color can be expressed in terms of the two color coordinates, x and y. A given color can, therefore, be plotted as a point in an (x, y) chromaticity diagram. When a narrowband SPD comprising power at just one wavelength is swept across the wavelength range 400 nm to 750 nm, it traces a shark-fin shaped spectral locus in the (x, y) coordinates. All visible colors are contained within this spectral locus.

It has been found, experimentally, that for certain designs of ceramic metal halide lamps individual lamps exhibit a wider than acceptable range of (x, y) coordinates, leading to an unacceptable color spread in the chromaticity diagram. An example of acceptable and unacceptable color spread is shown in FIGS. 1 (a) and (b), respectively, wherein each point represents a single lamp. It is noted that identical manufacturing and normal design guidance as per industry standard were used to construct the lamps whose (x, y) coordinates are shown in FIGS. 1 (a) and (b), yet they consistently show the color spread behavior as described.

With further reference to FIGS. 1 (a) and (b), a 6 step McAdam ellipse is drawn around the (x, y) coordinates of these individual lamps. In the study of color vision, MacAdam ellipses refer to the region on a chromaticity diagram which contains all colors which are indistinguishable, to the average human eye, from the color at the center of the ellipse. The contour of the ellipse therefore represents the just noticeable differences of chromaticity. A point lying outside a given ellipse would appear to have a different color to an average human observer. The size of the ellipse (i.e., number of steps required to reach a noticeable chromaticity difference), is another representation of the color spread of the light source or object. Generally speaking, up to a 6 step ellipse is considered acceptable. In FIG. 1 (a) all of the sample lamps are contained within the 6 step ellipse, whereas several sample lamps in FIG. 1 (b) are outside the 6 step ellipse, thus the color variation of the population of lamps in FIG. 1 (b) would be deemed unacceptable.

Another metric used to measure color variation is the standard deviation in correlated color temperature (CCT) of the light source, sometimes referred to herein as “sigma CCT”. CIE defines the CCT as the temperature of a Planckian radiator whose perceived color most closely resembles that of a given or known source at the same brightness and under specified viewing conditions.

Some low wattage ceramic metal halide lamps are acknowledged to have poor color consistency, i.e., substantially identically manufactured lamps may render emitted light of varying hue. This holds true not only for comparable lamps of different manufacturers, but also for lamps manufactured by a single manufacturer. Until now, attempts to better control the variation in color between comparable lamps, i.e. lamps meeting the same industrial and performance standards, have proven unsuccessful for some low wattage ceramic metal halide lamps. There is a need, therefore, in the industry for a mechanism wherein the color emitted by a lamp may be better controlled, and for lamps exhibiting such color control.

Provided herein is a design for low wattage ceramic metal halide lamps where the shortcomings with respect to color control are obviated, without impacting other essential performance features of the lamp.

### SUMMARY OF THE DISCLOSURE

The invention provides a ceramic metal halide lamp including a ceramic discharge chamber, a halide fill disposed in the discharge chamber, and at least one electrode sealed within the discharge chamber, the electrode having a shank outer diameter (SD) of an optimum value, and a shank length (SL) of optimum value, such that the ratio of SL/SD satisfies the expression: 5.1≦SL/SD≦15.5, wherein the lamp exhibits a standard deviation for CCT of less than about 100° K.

In one embodiment of the invention, by carefully choosing the shank diameter and shank length, as defined herein, control of the color variability for low wattage CMH lamps is achieved, resulting in the capability to consistently produce populations of lamps with acceptable color.

It is an advantage of the foregoing that lamps having shank length and shank diameter as defined herein have yielded hitherto unknown relationships between these parameters and color control of CMH lamps.

It is another advantage of the invention disclosed herein that the foregoing principles, when combined with lamp does containing intentionally dosed oxygen, as described in US 2009/0146571 and US 2009/0146576, to our common assignee, describing use of intentionally dosed oxygen with regard to providing a wall clean-up cycle, provide for superior lamp performance.

### BRIEF DESCRIPTION OF THE DRAWINGS

FIG. 1(a) is a graph plotting (x, y) coordinates of a lamp design exhibiting acceptable color variation and FIG. 1(b) is a graph plotting (x, y) coordinates of a lamp design exhibiting unacceptable color variation;

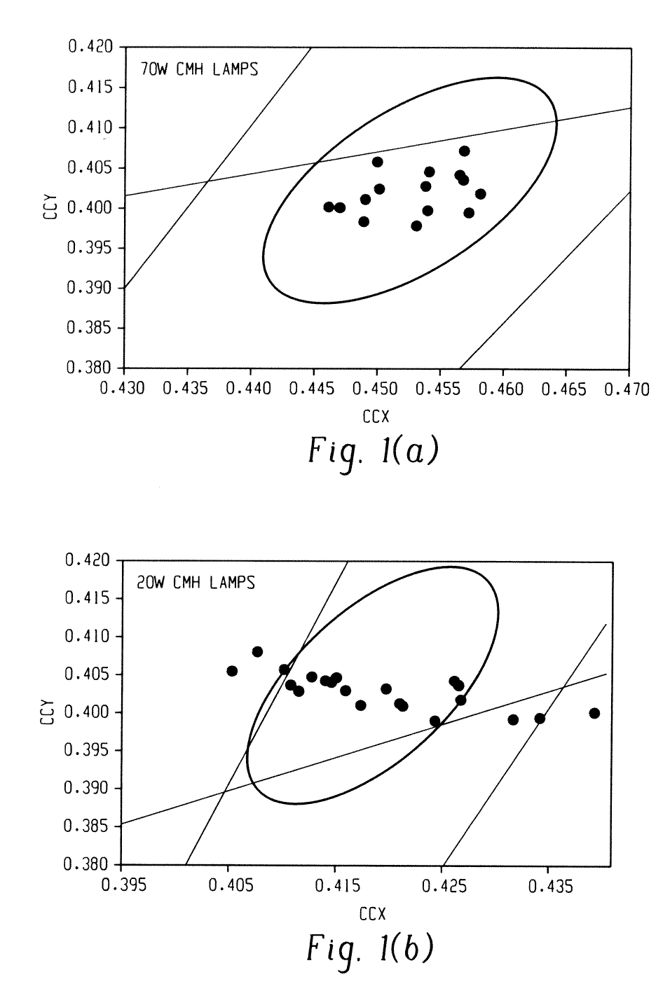

FIG. 2 (a) is a schematic diagram representing a CMH electrode assembly, and FIG. 2 (b) is an expanded schematic diagram of the electrode tip identifying shank diameter (SD) and shank length (SL);

FIG. 3 is a graph plotting sigma CCT vs. the ratio of shank diameter to shank length in accord with an embodiment of the invention, for a fixed quantity of oxygen in the lamp;

FIG. 4 is a graph illustrating shank tip temperature as a function of shank diameter in accord with an embodiment of the invention;

FIG. 5 is a surface plot of the standard deviation of lamp CCT as a function of shank length and shank diameter in accord with an embodiment of the invention;

FIG. 6 is a graph showing standard deviation of lamp CCT as a function of shank length in accord with an embodiment of the invention;

FIG. 7 is a surface plot of sigma CCT as a function of oxygen content and shank length in accord with an embodiment of the invention; and

FIG. 8 is a graph showing the effect on standard deviation of lamp CCT of decreasing shank length in accord with an embodiment of the invention.

### DETAILED DESCRIPTION OF THE PREFERRED EMBODIMENTS

The invention relates generally to ceramic metal halide lamps. More particularly, the invention relates to low wattage ceramic metal halide lamps having enhanced color control. In one embodiment according to the invention, such lamps may be characterized by a shank length (SL) to shank diameter (SD) ratio of between 5.1 and 15.5. Further, the lamp exhibits a sigma CCT of less than about 100° K.

Terms which are not specifically defined herein shall have the meaning attributed to them by those skilled in the relevant field of technology. As used herein, the term “low wattage” refers to a lamp wattage of about 20 w to about 400 w, with respect to conventional CMH lamps. Further, this term may be used with regard to those lamps having oxygen intentionally dosed, for example, to enhance wall cleanup reactions. Of course, it is to be understood that while today's lamps generally operate at a lower limit of 20 w, the principles provided herein are expected to any low wattage lamp, even lamps that may operate below this lower limit.

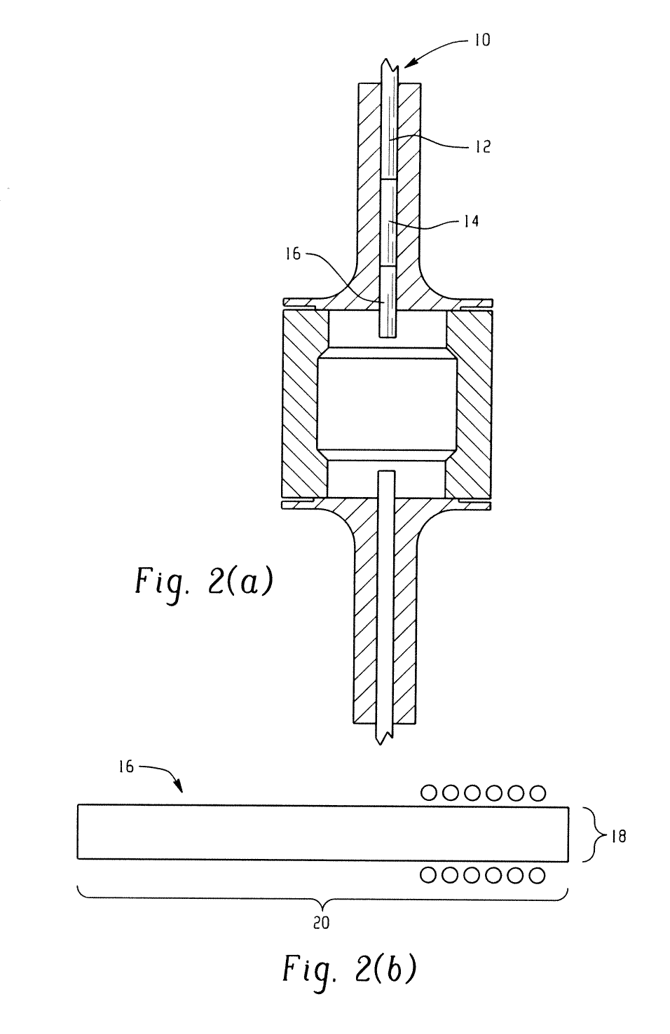

FIG. 2 provides a schematic diagram of a CMH lamp electrode. With reference thereto, in FIG. 2 (a) electrode 10 includes a rod having a portion of niobium 12 in operative contact with molybdenum portion 14 from which shank 16 extends. Shank 16 generally comprises tungsten, though other electrode material, including but not limited to Ta, Re, Pt, and Ti, may be used. Similarly, portion 12 may comprise Niobium or Ru, Zr, Ta, Mo, Os, Re, or W, or combinations thereof, and molybdenum portion 14 may instead comprise Ru, Zr, Ta, Os, Re, or W, or combinations thereof. In FIG. 2 (b), an expanded version of just the shank 16 is shown to have a certain diameter 18, SD, and a certain length SL, 20. As used herein, the “ratio of shank length to shank diameter” is determined by measuring the length 20 of the shank 16 and the outer diameter 18 of the shank 16, as shown in FIG. 2. The length should be measured from the tip of shank 16 to the distal end of electrode 10 where the electrode connects through the lamp structure, for example through a PCA pinch (not shown).

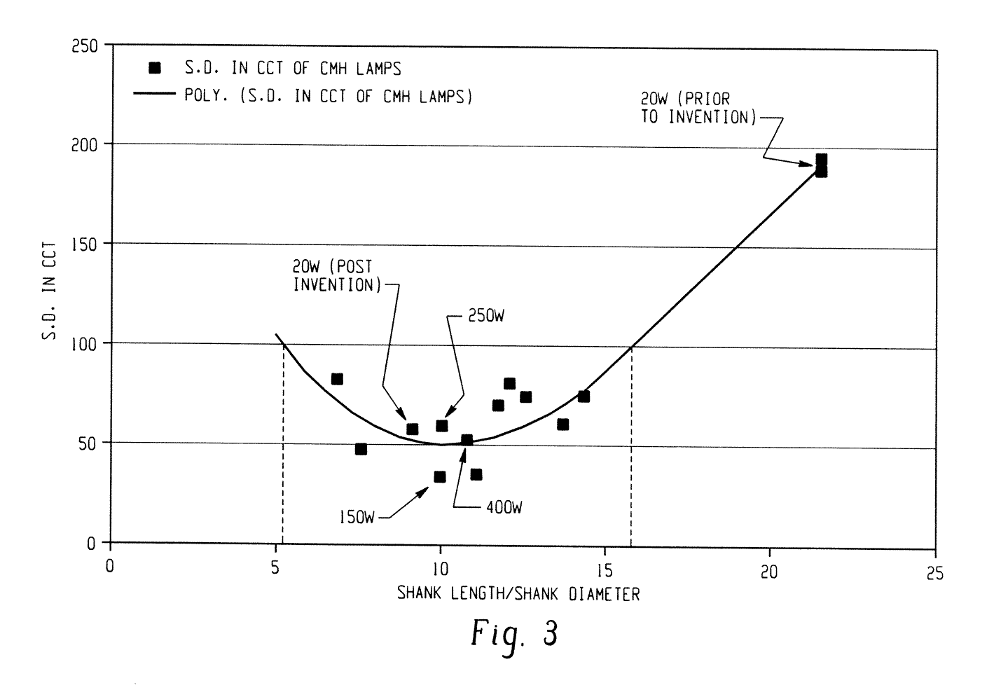

As has been stated, sigma CCT refers to the standard deviation of CCT values for individual lamps. Based on this parameter, and as shown in the graph set forth as FIG. 3, it is established herein that in order to achieve sigma CCT of less than 100° K, a ratio of shank length to shank diameter satisfying the following expression must be achieved:

5.1≦SL/SD≦15.5

This range can be obtained by polynomial analysis of FIG. 3, i.e., by estimating the two limits in this graph where the standard deviation in CCT crosses 100° K. Therefore, the figure describes the limits of Shank Length/Shank Diameter, in accordance with the invention, for which standard deviation in CCT of equal to or lesser than about 100 is achieved. Shown on the graph by various data points are lamps at various wattages that fall within the desired SL/SD range. Also shown, on the right portion of the graph is a prior art 20 w lamp, which is shown to have a SL/SD well outside the desired range, as well as a sigma CCT of almost 200° K. As will be set forth in more detail hereinafter, this prior art lamp is unacceptable according to the standard provided herein.

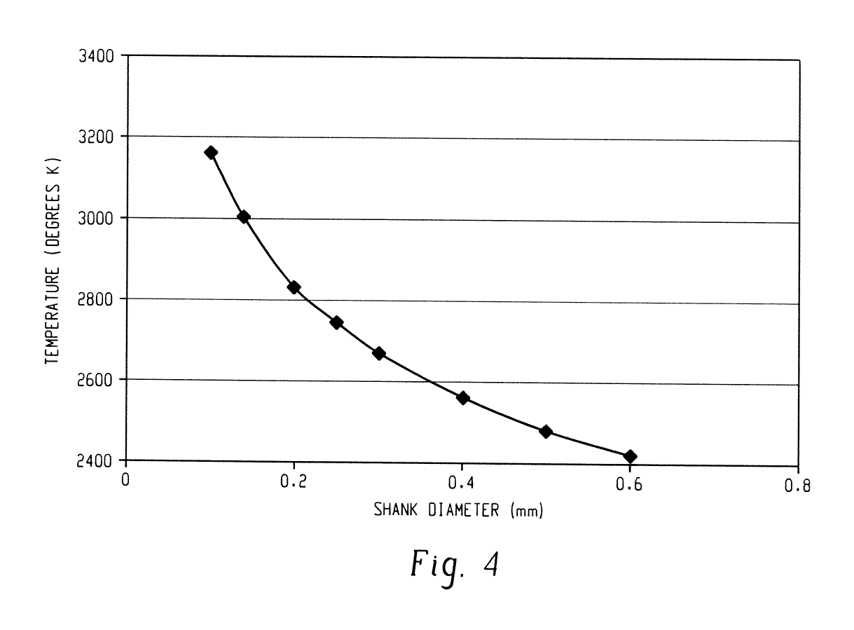

Shank diameter is generally established with regard to several considerations pertaining to lamp performance. One such consideration is the shank tip temperature. FIG. 4 provides a graph illustrating the dependence of shank tip temperature as a function of increasing shank diameter. This graph assumes fixed lamp power (20 w) and fixed shank length (2 mm). Desirable shank tip temperature for a standard CMH lamp is dependent upon several different lamp parameters, including shank diameter, shank length, lamp current, and heat transport away from the shank. This heat transport may result from radiative losses and/or conduction losses in the shank. For example, a CMH lamp, regardless of the wattage of operation, may desirably have a shank tip temperature of between about 2800° K and 3200° K. In this range, the lamp will operate optimally. Above this range, however, tungsten may be to quickly eroded and evolved causing lumen degradation. Below this range, the lamp may experience start-up and sustaining issues. With reference to FIG. 4, it is seen that for a 20 w CMH lamp with a shank having a length of 2 mm, the optimal shank tip temperature range, of between 2800° K and 3200° K, coincides with a shank diameter of from about 0.1 mm to about 0.2 mm. When the shank diameter is too narrow, i.e., less than an optimum 0.1 mm, the tip temperature is too high, leading to the above-mentioned problem of rapid evolution of tungsten material from the shank, causing lumen degradation. At a shank diameter wider than optimal, i.e. wider than 0.2 mm, FIG. 4 indicates that the tip temperature is reduced, resulting in the lamp experiencing difficulty with starting or transitioning from glow to full arc. Although operation of the lamp such that the tip temperature remains low may help in reducing the amount of tungsten evaporated during steady state operation, a low tip temperature can lead to the noted starting and sustaining issues with the lamp, and additionally to poor photometric quality of the emitted light, among other drawbacks.

In practice, there is typically a correlation between lamp performance and shank diameter. Therefore, having determined an optimum diameter for a given lamp wattage, optimum lamp performance may be achieved even for varied shank length so long as the ratio of SL/SD falls within the expression: 5.1≦SL/SD≦15.5.

In order to develop an optimal electrode design meeting the stated criteria, it is assumed first that the shank length will generally be greater than the shank diameter, as a length shorter than the diameter would prove unworkable. With the foregoing in mind, tests were performed, holding various parameters constant, to test the effect of each parameter on the ratio SL/SD, while simultaneously achieving a sigma CCT below 100° K. The following sets forth this testing and the resulting data.

Lamps tested were developed according to technical standards acceptable within the industry for providing quality lighting. Such standards are published in accord with ANSI and IEC (International Electrotechnical Commission) guidelines, and individual HID lamp company published documents. Given that various commercially available lamps, though developed and marketed by different manufacturers, are intended to achieve the established standards for operation and life, lamps of the same wattage may for many purposes be compared if tested in an identical manner. In this regard, lamps from several known sources were tested to determine sigma CCT.

Three sample lamps, A, B, and C, representative of 20 watt lamps commercially available from different manufacturers at the time of filing, were used. Each lamp was tested under identical conditions and their photometric output after 100 hrs, in vertical burning position, was measured. The resulting data, shown in Table 1, indicates that comparable 20 watt lamps, from several commercial vendors and manufactured in accord with established industry standards, each exhibited a standard deviation of CCT, or sigma CCT, of greater than 100° K, indicating a lack of consistency in the color of emitted light. Also considered was the geometry of the lamps tested. Table 1 sets forth that while lamps A and C had a cylindrical geometry, lamp B had a spherical geometry. With all other parameters held constant, the data again indicates that for the representative lamps tested, A, B, and C, the standard deviation of CCT was greater than 100° K. Therefore, it has been determined that neither lamp position during operation nor discharge chamber geometry has a significantly affect on the standard deviation of CCT.

TABLE 1

| CMH Lamp | Design | Wattage | CCT | Sigma |
|---|---|---|---|---|
| A | Cylindrical | 20 w | 3002 | 129 |
| B | Spherical | 20 w | 3147 | 118 |
| C | Cylindrical | 20 w | 3048 | 189 |

Table 2 provides data from testing undertaken to determine if the lamp chemistry alone has a significant effect on sigma CCT of the lamp. The lamp fill chemistry, or the dose, for each lamp tested is provided. In this regard, Na—Ce refers to a chemistry comprising NaI:CeI₃:CaI₂:TlI, Na—Dy refers to a chemistry comprising Nal:DyI₃:TmI₃:HoI₃:TlI; and Na—La refers to a chemistry comprising NaI:LaI₃:CaI₂:TlI. As with the prior testing, all other parameters of the lamps were identical and within industry standards for 20 w lamps, and no lamp exhibited a SL/SD within the desired range. The standard deviation in CCT, which is shown for each lamp to be above the 100° K limit, is shown as mid-value and a range with 95% confidence, using a Chi-Square distribution. It is seen that the ranges overlap, and therefore tests done on this data set cannot find a statistical difference in standard deviations between these chemistries.

TABLE 2

| CMH Lamp | Chemistry | 95% Lower | Sigma | 95% Upper |
|---|---|---|---|---|
| A | Na—Ce | 106 | 137 | 190 |
| B | Na—Dy | 125 | 189 | 366 |
| C | Na—La | 92 | 122 | 181 |

### Example 1

### Effect of Shank Length on Sigma CCT

Having determined that lamp operating position, lamp geometry and lamp chemistry do not significantly, in and of themselves, effect sigma CCT, testing was conducted to determine the effect of shank length on sigma CCT. Commercially available designs for ceramic discharge chambers were tested. As with the previous testing, all other lamp parameters were held constant, including a shank diameter of 0.14 mm, and only the shank length was varied. According to the data set forth in Table 3 below, shank length is a lamp parameter that does, in fact, affect sigma CCT. Therefore, by achieving an optimum shank length for a given diameter, the sigma CCT can be kept below 100° K, which correlates to acceptable color quality of the lamp. As shown in Table 3, shank length was varied from 3 mm, to 2 mm and then to 1.5 mm. For shank length less than 3 mm, sigma CCT is well below the upper limit of 100° K. The evidence of complete absence of overlap in the Upper and Lower 95% confidence values for standard deviation (sigma) shows clearly that the shorter shank lengths correlate to a highly significant effect in reducing variation in CCT among comparable lamps having been identically, or even similarly, constructed.

TABLE 3

| # Samples | | | | |
|---|---|---|---|---|
| Tested* | Shank Length | 95% Lower | Sigma | 95% Upper |
| 27 | 3 | 92 | 122 | 181 |
| 78 | 2 | 58 | 69 | 86 |
| 48 | 1.5 | 55 | 69 | 91 |

*Shank Diameter constant at 0.14 mm and all other lamp parameters held constant.

### Example 2

### SL/SD

With reference back to FIG. 2, of particular interest to the current lamp design is the shank outer diameter 18, SD, and shank length 20, SL, and the relationship of the two as a ratio of SL/SD. In this Example, the diameter and length of the electrode shank were varied to determine optimum SL/SD. FIG. 4, as stated herein above, provides a graph of shank tip temperature as a function of shank diameter, establishing that shank diameter of between about 0.1 mm and 0.2 mm is optimal. Table 4 below sets forth the diameter and length of each electrode considered as part of this Example, as well as the ratio of SL/SD. As with the foregoing testing, all of the lamps used to develop this test data were commercially available 20 w CMH lamps of identical design, holding all parameters constant other than the shank diameter and length, which varied in accord with Table 4. The chemistry for all lamps tested was NaLTlI:CaI₂:LaI₃, with intentionally dosed oxygen (see also details in Example 4). All combinations of shank length and diameter shown meet the expression: 5.1≦SL/SD≦15.5, with the exception of lamp I, which has a SL/SD ratio of 21.4, well outside the acceptable range.

TABLE 4

| | | | Shank Length/ |
|---|---|---|---|
| CMH Lamp | Shank Diameter | Shank Length | Shank Diameter |
| G | 0.14 | 1.5 | 10.7 |
| H | 0.14 | 2 | 14.3 |
| I | 0.14 | 3 | 21.4 |
| J | 0.2 | 1.5 | 7.5 |
| K | 0.2 | 2 | 10.0 |
| L | 0.25 | 2 | 8.0 |
| M | 0.25 | 3 | 12.0 |
| N | 0.22 | 1.5 | 6.8 |
| O | 0.22 | 2 | 9.1 |

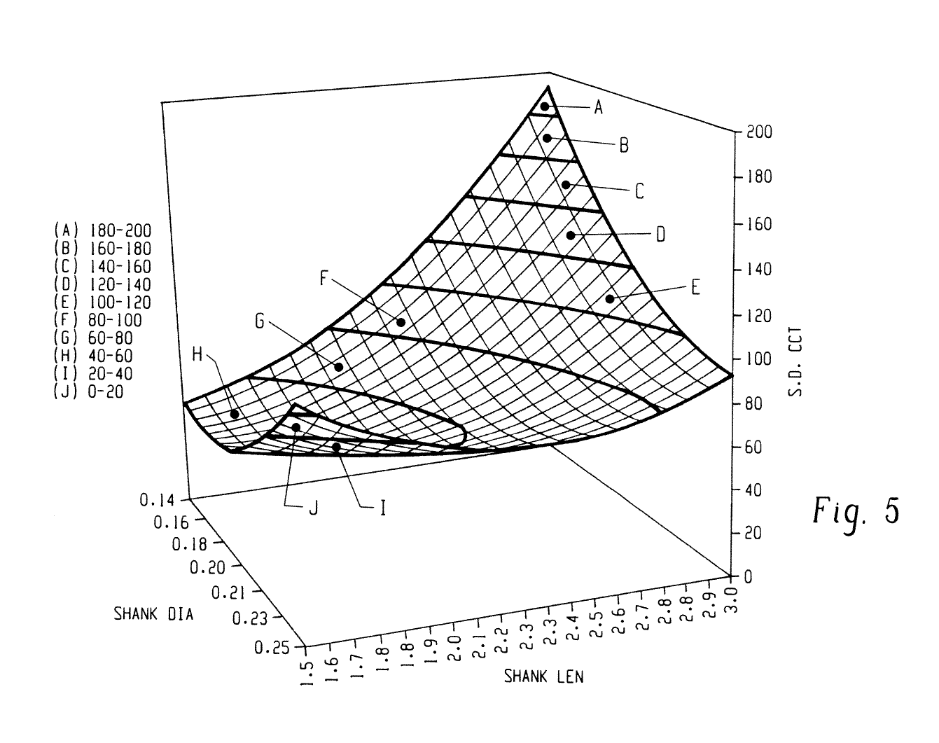

FIG. 5 provides a surface plot of standard deviation of CCT as a function of shank length and shank diameter, as generated from lamps having the lamp chemistry described above in Example 2. Using this graph, one can determine, for a 20 w lamp, the relationship between shank diameter and length necessary to achieve a standard deviation of CCT of less than 100° K. The minimal relationship, according to the diagram, is achieved by a shank diameter of 0.14 mm and a shank length of 1.5. Therefore, at a shank diameter of 0.14 mm, the surface plot predicts that a shank length of 1.5 would be required to achieve a minimum standard deviation of lamp CCT of approximately 50° K, i.e., well below the 100° K maximum target. Table 5 provides a sampling of acceptable lamp design parameters, i.e. SL/SD, generated from FIG. 5 and that achieve lamp CCT below the acceptable maximum target of 100° K, thus illustrating the correlation of these parameters as shown by FIG. 5.

TABLE 5

| Shank Length | Shank Diameter | Sigma CCT |
|---|---|---|
| 1 | 0.2 | 86 |
| 1.5 | 0.2 | 58 |
| 2 | 0.2 | 54 |
| 1 | 0.15 | 53 |
| 1.5 | 0.15 | 48 |
| 2 | 0.15 | 67 |

### Example 3

### Increasing Shank Length

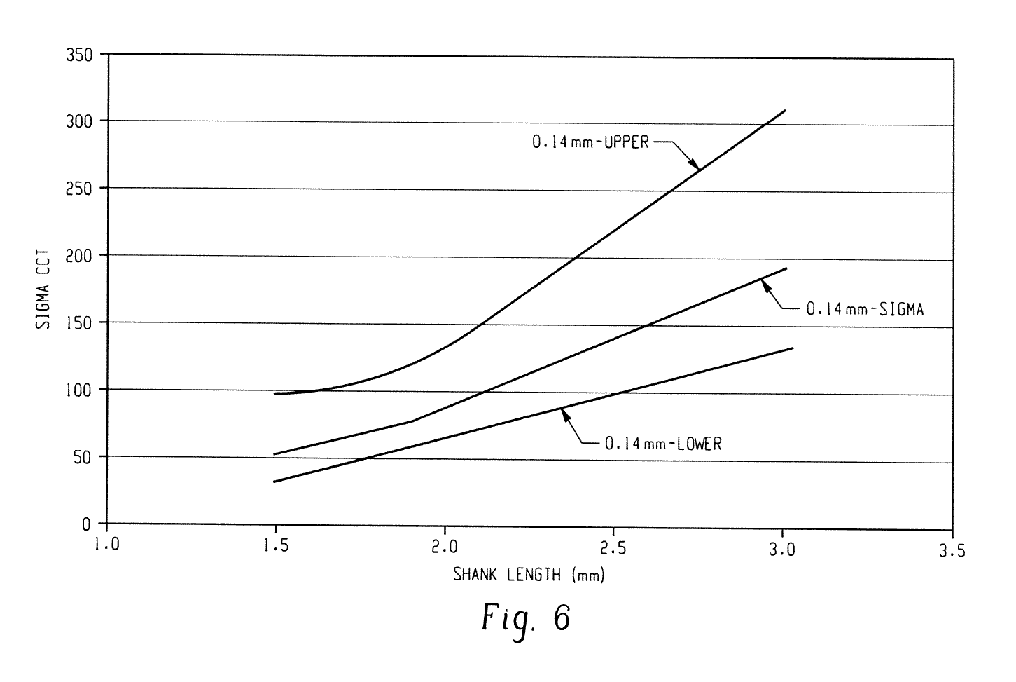

Example 3 is provided to demonstrate the effect on sigma CCT of increasing shank length. In this regard, FIG. 6 provides yet another graphic representation of the underlying principle of the invention. The graph in FIG. 6 shows sigma CCT as a function of the shank length. As can be seen, the sigma value 95% Confidence limits for sigma CCT increase with increasing shank length, and will eventually become unacceptable. For example, at a shank length of 3 mm, standard deviation in CCT was about 200° K, double the minimum acceptable level 100° K. The data represented in FIG. 6 was obtained from the lamp tests described in Example 5 above. The 95% confidence intervals in sigma CCT were calculated from individual CCT values of the replicate lamps made for each row of Table 4, using a Chi-Squared distribution function.

### Example 4

### Oxygen Content

Another variable that was tested in order to confirm the effect of shank length on sigma CCT was the oxygen content. This parameter was tested because it is known that oxygen content in CMH lamps can improve the maintenance of lumens with burn hours. In order to best ascertain the effect of shank length on CCT, even under variation in oxygen content, lamps were constructed using the following constants: ceramic discharge chamber with 20 w power, a measurement of about 0.925 mm from shank tip to PCA, sometimes referred to as the tip-to-PCA measurement, and a shank diameter (SD) of 0.14 mm. In order to maintain the 0.925 mm tip-to-PCA measurement, the molybdenum portion of the electrode was varied, i.e., increased or decreased as necessitated by the change in shank length. The dose comprised NaI (71.9%), TlI (4.1%), CaI₂ (17.5%) and LaI₃ (6.5%) in molar percent, having a total dose weight of 6 mg. The test compared oxygen content of 0.3 μm, 0.8 μm and 1.3 μm per cc arc-tube volume of oxygen, in lamps having varying shank lengths (SL) of 1.5 mm, 2 mm and 3 mm.

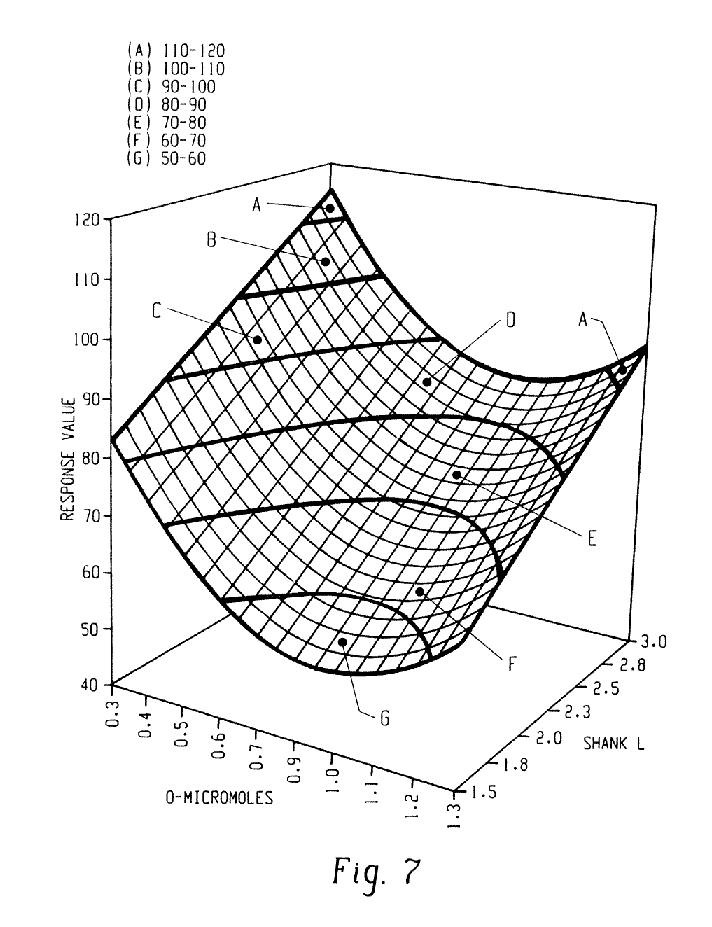

The influence of oxygen content and shank length on sigma CCT is shown in FIG. 7, which is a surface plot of sigma CCT as a function of oxygen content and shank length. From this figure, it is seen that as long as the shank length is below 2 mm, the oxygen content can be varied over a wide range, and still yield sigma CCT below 100° K. For greater oxygen content, the data indicates that the sigma CCT is trending upwards. For a 3 mm shank length, and a shank diameter of 0.14 mm, similar trends are seen, but the sigma CCT values for 3 mm shanks are all greater than 100° K, i.e., they are unacceptable. This data supports the conclusion that by shortening the shank length to less than 3 mm, the standard deviation of CCT would be well below the desirable maximum of 100° K, over a wide range of doped oxygen content.

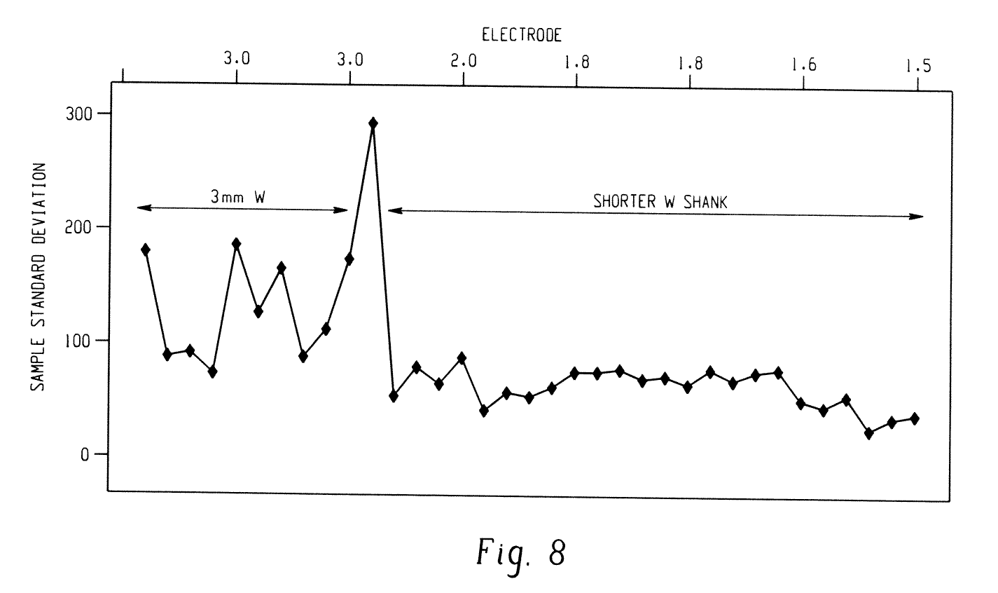

FIG. 8 provides a graph showing cumulative data regarding standard deviation of multiple samples, with all other parameters being held constant, and with increasingly shorter shank length (SL). Each dot on the plot in FIG. 8 represents a different lamp test, with several replicates per test. The standard deviation at the 3 mm shank length varied for the most part between 100° K and 200° K, above the desired maximum of 100° K. In contrast, as the shank length was shortened below 3 mm, the sigma CCT fell consistently below the desired 100° K maximum, as supported by multiple tests.

Based on the foregoing, it has been shown that sigma CCT below 100° K may be achieved using a shank diameter to shank length ratio that satisfies the expression 5.1≦SL/SD≦15.5. By achieving a sigma CCT below 100° K, the color of the lamp will be more consistent. Table 6 below sets forth further data to support the foregoing. In this Table, SL/SD is the ratio of the shank length to shank diameter. Measured Sigma in CCT is shown in the second column. Statistical treatment of this data indicates that if the ratio SL/SD is confined within the range of 5.1 to 15.5, the sigma CCT will be below 100° K. These ratios, if added to the graph shown in FIG. 3 would all fall between the dashed lines at a ratio of 5 and 15.5, with the exception of the last lamp tested, which is shown on FIG. 3 to have a sigma CCT closer to 200° K.

TABLE 6

| SL/SD | Sigma CCT |
|---|---|
| 7 | 82 |
| 8 | 47 |
| 9 | 57 |
| 10 | 58 |
| 11 | 52 |
| 12 | 80 |
| 14 | 75 |
| 21 | 192 |

The invention has been described with reference to the preferred embodiments. Obviously, modifications and alterations will occur to others upon reading and understanding the preceding detailed description. It is intended that the invention be construed as including all such modifications and alterations.

What is claimed is:

1. A ceramic metal halide lamp comprising:
a. a ceramic discharge chamber;
b. a halide fill disposed in the discharge chamber;
c. at least one electrode sealed within the discharge chamber, the electrode including a shank having a ratio of shank length to shank diameter, SL/SD, satisfying the expression 5.1≦SL/SD≦15.5.

2. The lamp of claim 1 wherein the lamp exhibits a standard deviation of CCT of less than about 100° K.

3. The lamp of claim 1 wherein the shank length is from about 1 mm to about 2.5 mm.

4. The lamp of claim 1 wherein the shank diameter is from about 0.1 mm to about 0.2 mm.

5. The lamp of claim 1 wherein the lamp is a low wattage lamp design.

6. The lamp of claim 3 wherein the lamp has a wattage of from about 20 watts to about 400 watts.

7. The lamp of claim 2 wherein the lamp is a 20 watt lamp.

8. The lamp of claim 1 wherein the ratio SL/SD is 8≦SL/SD≦12.0.

9. The lamp of claim 1 wherein the ratio SL/SD is about 14.

10. The lamp of claim 8 wherein the standard deviation of CCT is less than about 85.

11. The lamp of claim 8 wherein the standard deviation of CCT is less than about 64 and the ratio of SL/SD is about 11.

12. The lamp of claim 1 wherein the dose comprises one of NaI:CeI₃:CaI₂:TlI, NaI:DyI₃:TmI₃:HoI₃:TlI, and NaI:LaI₃:CaI₂:TlI.

13. The lamp of claim 12 wherein the dose further includes intentionally dosed oxygen.

14. The lamp of claim 1 wherein the shank length is 1.5 mm and the shank diameter is 0.14 mm, the lamp is a 20 watt lamp, and the CCT is less than about 75° K.

15. A method of reducing variation in CCT among multiple low wattage CMH lamps of comparable design, the method comprising:
providing multiple low wattage CMH lamps wherein each lamp includes:
a ceramic discharge chamber having a halide fill disposed therein; and
at least one electrode sealed within the discharge chamber, the electrode having a shank at the tip thereof having a ratio of SL/SD satisfying the expression 5.1≦SL/SD≦15.5;
wherein each lamp exhibits a CCT below 100° K.

16. The method of claim 15 wherein each lamp of the multiple low wattage CMH lamps is dosed with a fill comprising at least one of NaI:CeI₃:CaI₂:TlI, NaI:DyI₃:TmI₃:HoI₃:TlI, and NaI:LaI₃:CaI₂:TlI, with the proviso that all lamps have the same dose.

17. The method of claim 15 wherein each lamp of the multiple low wattage CMH lamps emits visible light having the substantially the same hue.

18. The method of claim 17 wherein the CIE (x, y) coordinates of each lamp of the multiple low wattage CMH lamps lie within the same McAdam Ellipse.

19. An electrode assembly for use in a low wattage CMH lamp, the assembly comprising at least an electrode having a shank portion exhibiting a shank length to shank diameter ratio, SL/SD, of between 5.1 and 15.5, and exhibiting an electrode tip temperature of between about 2800° K and about 3200° K.

20. The electrode assembly of claim 19 wherein the electrode has a first portion, a middle portion, and a shank portion.

21. The electrode assembly of claim 20 wherein the first portion is selected from Nb, Ru, Zr, Ta, Mo, Os, Re, W, or combinations thereof, the middle portion Mo, Ru, Zr, Ta, Os, Re, W, or combinations thereof, and the shank portion is selected from W, Ta, Re, Pt, Ti, and combinations thereof.

22. The electrode assembly of claim 19 wherein the shank has a length of up to about 2.5 mm.

23. The electrode assembly of claim 19 wherein the shank has a diameter of up to about 0.2 mm.

24. The electrode assembly of claim 19 wherein the shank has a length of about 1.5 mm and a diameter of about 0.14 mm.
